(19) United States
(12) Patent Application Publication
(10) Pub. No.: US 2005/0111416 A1
(43) Pub. Date: May 26, 2005

(54) Method, system and device of fragmentation with group acknowledgement in wireless networks

(76) Inventor: Boris Ginzburg, Haifa (IL)

Correspondence Address: EITAN, PEARL, LATZER & COHEN ZEDEK LLP, 10 ROCKEFELLER PLAZA, SUITE 1001, NEW YORK, NY, 10020, US

(21) Appl. No.: 10/718,812

(22) Filed: Nov. 24, 2003

(51) Int. Cl. H04Q 7/24

(52) U.S. Cl. 370/338; 370/395.53

(57) ABSTRACT

A method and device for transmitting data fragments with an indication that a fragment is a last fragment of a group. For example a source may transmit a last fragment in a group with an indication that it is a last fragment of such group. Upon receipt by a destination of a last fragment, the destination may transmit a group acknowledgment frame that may include data on the fragments of such group that were successfully received by such destination. A source may determine from the group acknowledgement frame whether any transmitted fragments of a group were not successfully received, and may retransmit fragments until all fragments in the group are successfully received by a destination.

### BACKGROUND OF THE INVENTION

Fragmentation of frames delivered over a network such as for example a wireless network may increase the reliability of frame transmission by for example reducing the likelihood of failures of transmitted frames. A source station such as for example a network interface card (NIC), an access point or other transmission device may use fragmentation to divide frames, such as for example frames delivered over a network communication using for example an IEEE Standard 802.11, (published 1999; ISO/IEC 802-11:1999), into smaller pieces or fragments, and send the smaller fragments to a destination. Smaller frames may reduce the likelihood of failures. The destination may assemble the received fragments back into a frame based on fragment order numbers found for example in the header of each fragment. A source station may transmit each fragment separately, and a receiving station may reply with a separate acknowledgement (ACK) of each fragment that it receives.

Fragmentation and the use of interim ACK frames to acknowledge receipt of fragments has drawbacks such as for example a resulting low channel utilization. The delivery of intermediate ACK frames between fragments may slow transmission by for example adding a period equal to the time required to transmit an immediate ACK frame and the short inter-frame-space (SIFS) intervals between the ACK frame and a next fragment to be transmitted. Block acknowledgement mechanisms such as for example those proposed in IEEE 802.11e (Quality of Service) Draft 4.1 may reduce the number of ACK frames between fragments, but may still require a set up process in the form of a start block acknowledgement (BA) request and start BA response at the beginning of a block of fragments, and a tear off process in the form of a stop BA request and stop BA response at the end of a block of fragments. Such BA start and stop requests and responses may have drawbacks such as for example reduced channel utilization or low throughput.

### BRIEF DESCRIPTION OF THE DRAWINGS

Embodiments of the invention will be understood and appreciated more fully from the following detailed description taken in conjunction with the drawings in which:

FIG. 1 is a schematic diagram of components of a station and of a network in accordance with an exemplary embodiment of the invention;

FIG. 2 is a schematic time line diagram of a series of data items such as fragments being exchanged between a source and a destination over time (t) in accordance with an exemplary embodiment of the invention;

FIG. 3 is a schematic time line diagram of fragments and frames including a channel access acknowledgment being exchanged between a source and a destination over time in accordance with an exemplary embodiment of the invention; and

FIG. 4 is a flow diagram depicting a series of operations for transmitting a group of fragments and a group acknowledgement frame in accordance with an exemplary embodiment of the invention.

### DETAILED DESCRIPTION OF THE INVENTION

In the following description, various aspects of the present invention will be described. For purposes of explanation, specific configurations and details are set forth in order to provide a thorough understanding of the present invention. However, it will also be apparent to one skilled in the art that the present invention may be practiced without the specific details presented herein. Furthermore, well-known features may be omitted or simplified in order not to obscure the present invention. Various examples are given throughout this description. These are merely descriptions of specific embodiments of the invention, but the scope of the invention is not limited to the examples given.

Unless specifically stated otherwise, as apparent from the following discussions, it is appreciated that throughout the specification, discussions utilizing terms such as “processing,” “computing,” “calculating,” “determining,” or the like, refer to the action and/or processes of a processor, computer or computing system, or similar electronic computing device, that manipulate and/or transform data represented as physical, such as electronic, quantities within the system's registers and/or memories into other data similarly represented as physical quantities within the system's memories, registers or other such information storage, transmission or display devices.

The processes and displays presented herein are not inherently related to any particular computer, communication device, article or other apparatus. A desired structure for a variety of these systems will appear from the description below. In addition, embodiments of the present invention are not described with reference to any particular programming language, machine code, etc. It will be appreciated that a variety of programming languages, machine codes, etc. may be used to implement the teachings of the invention as described herein.

As used in this application the following terms may in addition to their usual meaning in the art or otherwise, also have the following meanings: The term ‘fragmentation’ may mean for example breaking frames or other units of data such as for example medium access control (MAC) service data units (MSDU) into fragments such as for example medium access control protocol data units (MPDU) before transmission of the frame or data unit. The size of fragments may in some embodiments be set from for example, 256 bytes to 2436 bytes per fragment, and the size of fragments may in some embodiments be adjustable by a user or by a wireless local area network (WLAN) controller or other network controller. Other fragment sizes may be used and other triggers for implementing fragmentation may be used. A group of fragments that include data divided from a single frame may in some embodiments carry the same sequence number, with the fragments that include the data divided from a single frame having unique fragment numbers or other unique designation in the group. Sequence numbers and fragment numbers may in some embodiments be stored in for example a header of a fragment. Other configurations of fragments and other sequencing processes and storage areas for sequence numbers are possible.

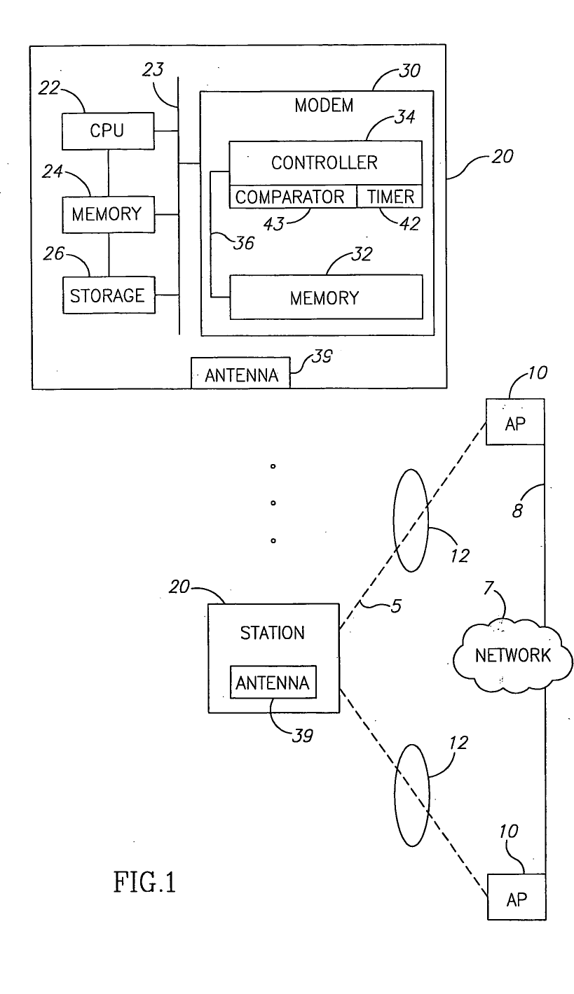

FIG. 1 is a schematic diagram of components of a station and of a network in accordance with an exemplary embodiment of the invention. Referring to FIG. 1, network 7 may for example include one or more peers, such as for example other wireless receiving and broadcasting devices, or access points (AP) 10, which may transmit to stations 20. Network 7 may for example be a wireless network or a network that includes wireless components. For example, in some embodiments, network 7 may be a local area network (LAN) with wireless links, such as a WLAN. In other embodiments, network 7 may be for example a wide area network (WAN). Peers or APs 10 may in some embodiments transmit frames or fragments to and from stations 20 or from other equipment such as for example personal computers, workstations, printers, etc. A station 20, AP 10, NIC or other device which may transmit a frame may be described as a source, and a recipient of a frame may be described as a destination. In some embodiments, a source in a particular transmission may be a destination in another or subsequent transmission. Traffic 5 between stations 20 and a peer or AP 10 may for example be radio waves carrying digital data. In other embodiments, traffic 5 may be in different forms such as infrared or other electromagnetic waves. Traffic 5 on a particular channel 12 may be subject to interference or collisions with other traffic or as a result of objects or other factors.

Peer, station or AP 10 may be for example a wireless bi-directional communications link, NIC or other wireless interface device through which wireless devices such as, for example station 20 or AP 10, may communicate with a network such as network 7. In embodiments of the invention, other communications links, having structures and functionalities other than those of an AP 10 may be used. In some embodiments, peers or APs 10 may be connected to each other or to network 7 or components of network 7 by wired links 8 or wirelessly.

Station 20 may be or include a wireless communication device. For example, station 20 may for example be a personal computer which may for example be portable (e.g., a “laptop”) and which may include a wireless modem 30 or a NIC. Such a wireless modem 30 may be, for example, a wireless network adaptor or may be another type of wireless communications device. Station 20 may be other computing devices, such as personal digital assistants, cellular telephones, etc.

Station 20 may include, for example, a controller or processor 22 (e.g., one or more central processing units (CPUs) or microprocessors), a memory or storage unit 24 (e.g., one or more random access memories (RAMs) or read only memories (ROMs) or other storage mediums), mass storage unit 26 (e.g., a hard disk or other non-volatile memory), one or more busses 23, and a wireless modem 30. Wireless modem 30 may include standard computational components, such as, for example, a controller 34, such as a microprocessor, CPU, etc., a memory unit 32, and one or more busses 36. Station 20 may in some embodiments include other or additional components such as for example a dipole antenna 39.

Network 7 may in certain embodiments be a WAN such as for example the Internet; a WLAN such as, for example, those that may connect a LAN to wireless stations, or smaller networks such as those used by components based on for example, the Bluetooth standard, such as scatternets, micronets or piconets, etc, or other suitable network configurations.

In some embodiments, either or both of processor 22 or controller 34 may act as a controller to carry out all or part of a method according to an exemplary embodiment of the present invention. While in FIG. 1 such components are shown in only one station 20, other stations 20 may include similar components. Some stations 20 may include different sets of components and different functionalities, and may carry out the methods discussed herein in different manners. In other embodiments having equipment with different configurations, different components may act as a controller 34. In some embodiments, a peer or AP 10 may also contain a controller. Instructions that may execute an embodiment of the invention may be stored for example in memory 32 or other storage medium and may be executed by for example controller 34, CPU 22 or other suitable processor.

A station 20 or a processor 22 or controller 34 within such station may include one or more timers 42 that may, among other functions, clock the speed, periodicity or cycles or the transmission or receipt of frames or fragments. In some embodiments, timer 42 may be located or included in components of for example station 20 or AP 10, other than controller 34. In some embodiments, controller 34 may include a comparator 43, capable of for example comparing data that may be stored in a memory 32 of modem 30 with data received by or from for example antenna 39.

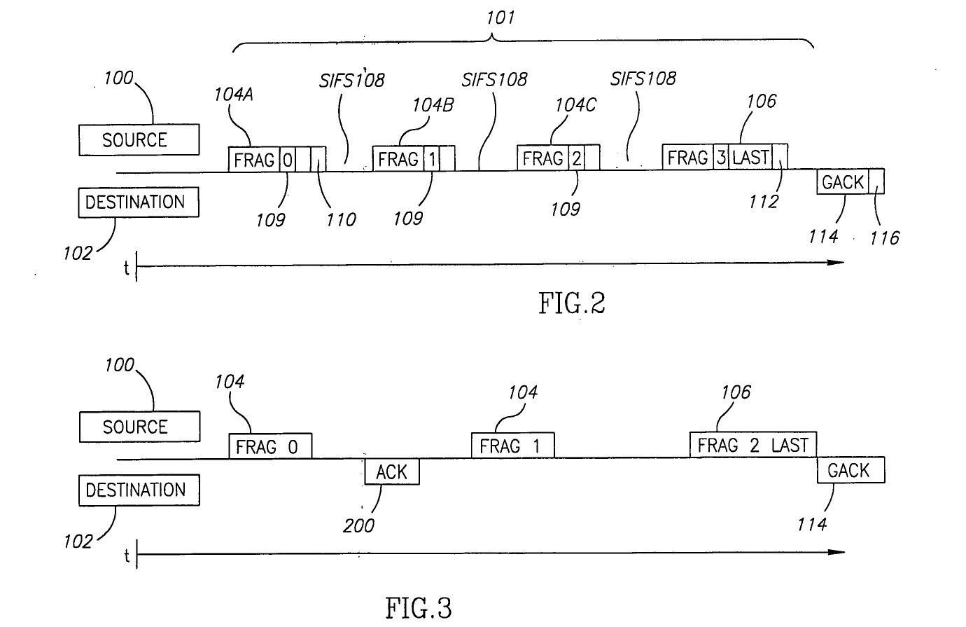

Reference is made to FIG. 2, a schematic time line diagram of a series of data items such as fragments being exchanged between a source and a destination over time (t) in accordance with an exemplary embodiment of the invention. In an exemplary embodiment of the invention, source 100 which may be controlled for example by a controller 34 within such source 100, may transmit a group 101 of fragments that may for example include data that had been divided from for example a larger frame or data unit by for example a fragmentation process. FIG. 2 depicts a group 101 of fragments 104 labeled Frag0 104A through Frag2 104C and a last fragment 106, labeled in FIG. 2 as Frag3. In some embodiments, a numbering or order sequence of fragments 104 in a group may be included in for example a heading 109 of a fragment 104. In some embodiments the numbering of fragments 104 in a group 101 may be sequential, beginning at for example 0 and incrementing by 1 with each successive fragment in such group 101. Other sequencing arrangements or methods are possible for providing sequencing to fragments 104 of a group 101 that carry the data of a frame. In some embodiments the number of fragments 104 in a group 101 may be as few as one, which may in some embodiments be a last fragment 106, or may be a plurality or may be as many as 10 or more fragments 104. In some embodiments, a group 101 of fragments 104 may carry the data of a single frame that had been fragmented into fragments 104. In some embodiments, an SIFS 108 interval or other interval may be left between fragments 104, during which interval or period frames may for example not be transmitted between source 100 and destination 102. In some embodiments fragments 104 may include a bit or other indication that such fragment 104 is not the last fragment to be transmitted in a group 101, or that more fragments 104 of such group 101 may be transmitted at a later time such as for example in a next fragment time slot. Such a bit or other indication may in some embodiments be designated as a ‘more fragments’ bit 110. In some embodiments, more fragments 110 bit may be configured in a frame control field of a fragment 104, though other configurations are possible. In some embodiments, a last fragment 106 may include an indication such as for example a bit in a designated state, to indicate that such last fragment 106 is the last fragment in a group 101. Such a bit or other indication may in some embodiments be designated as a ‘no more fragments’ bit 112. No more fragments bit 112 may for example indicate that a particular fragment is the last fragment 106 in such group 101. A more fragments bit 110 and no more fragments bit 112 may for example be included in a frame control field of a fragment 104. More fragments bit 110 and no more fragments bit 112 may for example be included elsewhere in a fragment 104, and may for example be in forms other than a single bit. For example, more fragments bit 110 and no more fragments bit 112 may in some embodiments be included in the same bit such that a bit in an on position may indicate more fragments, and the same bit in an off position may indicate no more fragments. Other configurations of more fragments bit 110 and no more fragments bit 112 are possible. A bit or other indicator that may be designated as a ‘no-ACK-required’ bit may be included in for example a frame control field of a fragment 104 to indicate to that destination 102 need not send an intermediate ACK following such fragment 104 or between such fragment 104 and the next expected fragment 104.

In some embodiments, in response to the receipt by a destination 102 of a no more fragments bit 112 or other suitable indication in for example a last fragment 106, destination 102 may transmit a group acknowledgement fragment 114 (GACK) or other suitable acknowledgment, data item or frame, back to for example source 100. In some embodiments, an indication, such as for example a no more fragments bit 112 in a last fragment 106 may function as a trigger or request for a destination 102 to transmit a GACK 114 or other suitable acknowledgement. In some embodiments, a no more fragments bit 112 or other indication of a last fragment 106 may take the place of a tear off process such as for example of a stop BA request and or other acknowledgment frame from a source 100 that all of the fragments 104 of a group 101 have been transmitted.

GACK 114 or other suitable acknowledgment, data item or frame may include data indicating for example, the number and position of the fragments 104 in group 101 that were successfully received by destination 102. Other data may also be included in a GACK 114. In some embodiments, the data in a GACK 114 may be included in other fragments that may be designated other than as a GACK 114.

In some embodiments, the configuration or structure of a GACK 114 may be for example similar to the structure of an ACK as may be used in communications on a wireless network based on 802.11 communication standards. As is described herein certain portions of a GACK 114 may be designated to store data on fragments 104 that were received by a destination 102. Other differences between a GACK 114 and an ACK are possible.

In some embodiments, source 100 may store in a memory the number and order of the fragments 104 of a group 101 that it transmitted, and compare, by way for example of a comparator 43, the data in the GACK 114 or other suitable acknowledgment, data item or frame relating to received fragments 104 and last fragment 106 against a stored record of transmitted fragments 104 and last fragment 106 in a group 101. In some embodiments, such a record may be stored in a memory such as for example memory 32 or storage unit 24. If such comparison indicates that all fragments 104 within group 101 were successfully received by destination 102, source 100 may for example proceed to transmit another or next frame. If the comparison indicates that less than all transmitted fragments 104 in a group 101 were successfully received, source 100 or for example a controller 22 of source 100, may determine which fragments 104 were not successfully received, and may retransmit such failed fragments 104 to destination 102. If a transmitted fragment 104 of a group 101 was determined not to have been received by destination 102, all of the fragments 104 in such group 101 may be retransmitted until a GACK 114 is received which indicates that all fragments 104 in a group 101 were received, or until the number of attempted transmissions of the group 101 exceeds a maximum re-try limit and the attempted transmission fails or times out. In some embodiments only the fragments 104 that were indicated in a GACK 114 as not received, may be retransmitted. In some embodiments retransmission of fragments 104 in response to a GACK 114 that indicates less than complete receipt of all fragments 104 in a group 101 may begin at the first fragment 104 that was indicated in GACK 114 as not successfully received and may continue with the rest of the fragments 104 in a group 101.

In some embodiments, destination 102 may transmit a GACK 114 or other suitable acknowledgment, data item or frame if in the course of its receipt of a train of fragments 104 of a group 101 and before receiving a last fragment 106, it does not successfully receive a fragment 104 within a period approximating or exceeding for example an SIFS 108 interval plus a time slot equal to the time required to transmit or receive a fragment 104. In some embodiments, such a quiet period during the transmission of a group 101 in which destination 102 does not receive a fragment 104 may be evidence for example of an interruption on a channel or in some other component involved in the transmission or reception process between destination 102 and source 100. In some embodiments, a GACK 114 that is transmitted following such an interruption or quiet interval may indicate that for example, one or more fragments 104 in a group 101 was not successfully received or that for example, a last fragment 106 of group 101 was not received. In some embodiments, source 100 may, in response to a GACK 114 or other suitable acknowledgment, data item or frame that was transmitted before a last fragment 106 is received by a destination 102, restart the transmission of the fragments 104 in such group 101 or retransmit certain of the fragments in such group 101 beginning for example with the fragments 104 of group 101 that were not received by destination 104. In some embodiments, the timing of transmission and receipt of frames and of SIFS 108 or other intervals may be measured by timer 42 or by another suitable component in a source 100 or destination 102.

In accordance with an exemplary embodiment of the invention, transmission of fragments 104 of a group 101 followed by a GACK 114 may eliminate or reduce the number of intermediate ACKs between fragments 104 in a group 101 that may be transmitted by a destination 102 as part of for example the transmission of a group 101 of fragments 104. In accordance with an embodiment of the invention, fragments 104 of a group 101 may be transmitted one after another with for example SIFS 108 between such fragments 104, but with a reduced number of interim ACK frames, or without intermediate ACK frames between two or more fragments 104. In some embodiments only a single ACK frame, in the form for example of a GACK 114 may be transmitted as part of the transmission and receipt of a group 101 of fragments 104.

In some embodiments, an indication of the number or position of fragments 104 in a group 101 that are successfully received by destination 102 may be recorded for example in a series of one or more bits or other memory units of one or more bytes 116 or other collections of memory units in for example GACK 114. For example, in some embodiments a number of bytes 116 may be designated in for example a header or a frame control field of a GACK 114 or elsewhere in a GACK 114 to indicate the fragments 104 of a group 101 that were received by for example destination 102. In some embodiments, to indicate the receipt for example of a first fragment 104 of a group 101, a designated bit or memory unit, in for example a first position of one of such designated bytes 116 may-be switched to on. Subsequently received fragments 104 in a group 101 such as for example a second, third or fourth fragment 104 of group 101 may similarly trigger bits in a second, third or fourth position of a designated byte 116 to be switched to on. A source 100 that may receive GACK 114 may compare the number and/or positions of bits in bytes 116 that are in an on position with the number and/or order of fragments 104 in a group 101 that were transmitted to, for example destination 102 to determine if any and which transmitted fragments 104 may not have been successfully received by destination 102. In some embodiments, where for example the number of fragments 104 is less than for example 16, two bytes 116 of 8 bits each may be sufficient to record the fragments 104 of a group 101 that are to be received by destination 102. In some embodiments an indication of receipt by a destination 102 of a fragment 104 may be included other than as a bit in an on position. For example such an indication may be made by setting a bit in an off position or by altering a particular structure of a GACK 114 or part thereof. Other suitable methods to match acknowledgement signals to particular fragments 104 may be used.

Reference is made to FIG. 3, a schematic time line diagram of fragments and frames including a channel access acknowledgment being exchanged between a source and a destination over time (t) in accordance with an exemplary embodiment of the invention. In some embodiments, a destination 102 may transmit an ACK 200 for example after it receives a first fragment 104 of a group 101 or at another time at or near the beginning of a transmission of fragments 104 in a group 101. The receipt of ACK 200 by source 100 may be an indication that channel access between source 100 and destination 102 has been achieved for a train of fragments 104, that there were for example no impairments or collisions such as for example initial collisions in the transmission between source 100 and destination 102, and/or that a selected channel may be available for transmissions between source 100 and destination 102. Other indicators of the availability of a channel or the absence of collisions such as initial collisions may be used.

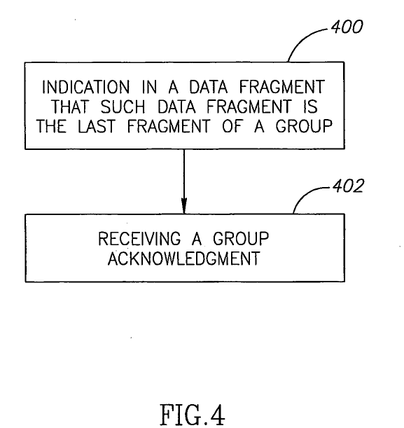

Reference is made to FIG. 4, a flow diagram depicting a series of operations for transmitting a group of fragments and a group acknowledgement fragment or other data item in accordance with an exemplary embodiment of the invention. In block 400, a group of one or more fragments 104 may be transmitted from a source 100 and may include an indication in a data fragment that such fragment is a last fragment in a group. In some embodiments, the fragments in such group may be transmitted without interim ACKs received by such source 100 between its transmission of two or more of such transmitted fragments.

A destination 102 or another component operably connected to a destination 102 may receive the fragments 104 that were transmitted by a source 100, and may track or record the number and/or the order of such received fragments 104 of the group 101 that it receives. In some embodiments, at the end of a train of fragments 104 of a group 101, such as for example when a last fragment 106 is received by a destination 102, a destination 102 may transmit a GACK 114 that includes data on the fragments 104 in the group 101 that the destination 102 successfully received. In some embodiments a GACK 114 may be transmitted by a destination 102 in response to other triggers such as for example if there is a quiet period prior to the end of a transmission of all fragments 104 of a group 101 during which it does not receive fragments 104 of the group 101, or for example if a destination 102 receives fragments 104 of a group 101 without a last fragment 106 or other indication of the end of the transmission of fragments 104 of a group 101.

In block 402 a source may receive a GACK or other acknowledgement, data unit or frame. In some embodiments, a GACK 114 may include data on the number and/or order of fragments 104 in a group 101 that were received by a destination 102. In some embodiments, a source 100 or other component operably connected to a source 100 may compare a record of the fragments 104 of a group 101 that it transmitted against the data in a GACK 114 indicating the fragments 104 of such group 101 that were successfully received by destination 102. In some embodiments, the data in a GACK 114 indicating the number and/or order of fragments 104 that were received by a destination 102 may be included in at least one byte 116 or other collection of memory units in a GACK 114. In some embodiments for example, bits in designated positions of such at least one byte 116 that may for example correspond to position of fragments 104 in a group 101, may be used to indicate the fragments 104 that were successfully received by a destination 102. In some embodiments, fragments 104 other than a last fragment 106 in a group 101 may include an indication that there are more fragments to be transmitted in such group.

In some embodiments, a last fragment 106 may for example have a configuration substantially similar to other transmitted fragments 104, except that such last fragment 106 may include an indicator that it is the last fragment or that it is in the end position of a group 101 of fragments 104 and that no more fragments 104 in such group 101 are to be expected by a destination 102. Other configurations of a last fragment 106 and other differences between a fragment 104 and a last fragment 106 are possible. In some embodiments, the receipt by a destination 102 of a last fragment 106 may serve as a trigger or request to such destination to transmit a GACK 114.

It will be appreciated by persons skilled in the art that embodiments of the invention are not limited by what has been particularly shown and described hereinabove. Rather the scope of at least one embodiment of the invention is defined by the claims below.

### Appendix A

Alan K. Aldous, Reg. No. 31,905; Shireen I. Bacon, Reg. No. 40,494: R. Edward Brake, Reg. No. 37,784; Ben Burge, Reg. No. 42,372; Robert Chang, Reg. No. 48,765; George Chen, Reg. No. 50,807; Glen B. Choi, Reg. No. 43,546; Kenneth Cool, Reg. No. 40,570; Jeffrey S. Draeger, Reg. No. 41,000; Cynthia Thomas Faatz, Reg No. 39,973; Christopher Gagne, Reg. No. 36,142; Sharmini N. Green, Reg. No. 41,410; Robert Greenberg, Reg. No. 44,133; Bradley Greenwald, Reg. No. 34,341; Jeffrey B. Huter, Reg. No. 41,086; Seth Z. Kalson, Reg. No. 40,670; Peter Lam, Reg. No. 44,855; Issac Lin, Reg. No. 50,672; David C. Lundmark, Reg. No. 42,815; Anthony Martinez, Reg. No. 44,223; Larry Mennemeier, Reg. No. 51,003; Paul Nagy, Reg. No. 37,896; Dennis A. Nicholls, Reg. No. 42,036; Lanny Parker, Reg. No. 44,281; Michael D. Plimier, Reg. No. 43,004; Michael Proksch, Reg. No. 43,021; Kevin A. Reif, Reg. No. 36,381; Crystal D. Sayles, Reg. No. 44,318; Kenneth M. Seddon, Reg. No. 43,105; Mark Seeley, Reg. No. 32,299; Ami P. Shah, Reg. No. 42,143; David Simon, Reg. No. 32,756; Steven P. Skabrat, Reg. No. 36,279; Howard A. Skaist, Reg. No. 36,008; Paul E. Steiner, Reg. No. 41,326; Joni D. Stutman-Horn, Reg. No. 42,173; David Tran, Reg. No. 50,804; Robert G. Winkle, Reg. No. 37,474; Sharon Wong, Reg. No. 37,760; Steven D. Yates, Reg. No. 42,242; Calvin E. Wells; Reg. No. 43,256; Michael Willardson, Reg. No. 50,856 and Charles K. Young, Reg. No. 39,435; my patent attorneys, and my patent agents, of INTEL CORPORATION, with offices located at 2200 Mission College Blvd., Santa Clara, Calif. 95052, telephone (408)765-8080; with full power of substitution and revocation, to prosecute this application and to transact all business in the Patent and Trademark Office connected herewith.

1. A method comprising indicating in a data fragment that said fragment is a last fragment of a group.

2. The method as in claim 1, wherein said indicating comprises requesting a group acknowledgment from a destination of said group.

3. The method as in claim 1, comprising receiving a group acknowledgement frame indicating the fragments in said group that were successfully received by a destination.

4. The method as in claim 3, wherein said receiving a group acknowledgment frame that indicates the fragments in said group that were successfully received comprises receiving at least one byte in said group acknowledgement frame wherein a bit of said byte in a designated position corresponding to a position of said fragment that was successfully received indicates that said at least one fragment was successfully received.

5. The method as in claim 1, further comprising comparing an indication of fragments successfully received by a destination against a record of transmitted fragments in said group.

6. The method as in claim 1, comprising transmitting a plurality of fragments without intermediate acknowledgement frames between at least two of said plurality of fragments.

7. The method as in claim 1, comprising transmitting an acknowledgment to indicate that a channel was accessed without collisions.

8. The method as in claim 1, comprising retransmitting at least one fragment in said group that was indicated in a group acknowledgement as being a fragment that was not successfully received.

9. A method comprising transmitting a group of fragments from a first station to a second station without said first station transmitting an acknowledgement request at the end of said group.

10. The method as in claim 9, further comprising transmitting a last fragment of said group with an indication of no more fragments in said group.

11. The method as in claim 9, further comprising transmitting a frame from said second station said frame from said second station including an indication of fragments in said group that were received by said second station.

12. The method as in claim 11, further comprising comparing said indication of said fragments in said group that were received by said second station with the number of fragments in said group that were transmitted by said first station.

13. The method as in claim 11, further comprising retransmitting from said first station fragments of said group transmitted by said first station that were not indicated as received in said frame from said second station

14. The method as in claim 11, wherein said transmitting a frame from said second station including an indication of fragments in said group that were received by said second station comprises transmitting at least one group acknowledgement frame in response to an interval during which said second station did not receive fragments of said group from said first station.

15. The method as in claim 14, wherein transmitting at least one group acknowledgement frame in response to an interval during which said second station did not receive fragments of said group from said first station, comprises, transmitting at least one group acknowledgement frame in response to an interval during which said second station did not receive fragments of said group from said first station, said interval comprising at least a period equal to a short inter-frame space plus at least one fragment slot.

16. The method as in claim 9, wherein said transmitting a group of fragments comprises transmitting a group of fragments without receiving a start block acknowledgment response.

17. An article comprising a storage medium having stored thereon instructions that, when executed by a processor, result in indicating in a data fragment that said fragment is a last fragment of a group.

18. The article as in claim 17, wherein said instructions further result in comparing an indication of fragments successfully received by a destination against a record of fragments in said group that were transmitted by a source.

19. The article as in claim 17, wherein said instructions further result in transmitting a plurality of fragments without intermediate acknowledgement frames between at least two of said plurality of fragments.

20. A communication device comprising:
a dipole antenna;
a processor to:
indicate in a data fragment that said fragment is a last fragment in a group.

21. The communication device as in claim 20, wherein said processor is to determine which fragments of said group were not successfully received by a destination.

22. The communication device as in claim 20, further comprising a memory to record a number and order of transmitted fragments of said group.

23. A device comprising a controller to indicate in a data fragment that said fragment is a last fragment of a group.

24. The device as in claim 23, comprising a comparator to compare data indicating the fragments of said group that were received by a destination against data indicating the fragments of said group that were transmitted by a source.

25. The device as in claim 23, wherein said controller is to control the retransmission of fragments in said group that were not received by a destination.

26. A method comprising:
transmitting from a source a group of data fragments including in a fragment of said group an indication that said fragment is a last fragment of said group; and
transmitting a group acknowledgement from a destination including data indicating the fragments in said group that were successfully received by a destination.

27. The method as in claim 26, comprising comparing an indication of fragments successfully received by said destination against a record of said transmitted fragments in said group.

28. The method as in claim 27, comprising retransmitting from a source fragments of a group that were not successfully received by said destination.
